(19) United States
(12) Patent Application Publication
(10) Pub. No.: US 2026/0072850 A1
(43) Pub. Date: Mar. 12, 2026

(54) Control Device And Method For Initializing A Control Device

(71) Applicant: Schaeffler Technologies AG & Co. KG, Herzogenaurach (DE)

(72) Inventors: Elias Huber, Obertraubling (DE); Gabriel Neumüller, Regensburg (DE)

(73) Assignee: Schaeffler Technologies AG & Co. KG, Herzogenaurach (DE)

(21) Appl. No.: 19/105,940

(22) PCT Filed: Aug. 24, 2023
(86) PCT No.: PCT/EP2023/073232

§ 371 Date: Feb. 24, 2025

(30) Foreign Application Priority Data
Aug. 31, 2022 (DE) 10 2022 209 019.5

(51) Int. Cl. G06F 12/14

(52) U.S. Cl. CPC G06F 12/1416; G06F 2212/1052

(57) ABSTRACT

Various embodiments of the teachings herein include a method for initializing a control device having at least one data processing unit, at least one nonvolatile memory for storing program code for the data processing unit, and at least one interface for accessing services provided by the control device. An example includes: starting the control device in an open operating mode; writing with a first service, a key to a predetermined memory area; switching to a protected operating mode after writing the key; and offering a second service for querying and/or changing data stored in the data processing unit and/or the nonvolatile memory in the protected operating mode. An access to the second service is safeguarded by the key written in the predetermined memory area.

### CROSS-REFERENCE TO RELATED APPLICATIONS

This application is a U.S. National Stage Application of International Application No. PCT/EP2023/073232 filed Aug. 24, 2023, which designates the United States of America, and claims priority to DE Application No. 10 2022 209 019.5 filed Aug. 31, 2022, the contents of which are hereby incorporated by reference in their entirety.

### TECHNICAL FIELD

The present disclosure relates to data processing. Various embodiments of the teachings herein include control devices comprising at least one data processing unit, at least one nonvolatile memory and at least one interface, and methods for initializing such a control device.

### BACKGROUND

Control devices are widely known from the prior art. For example, control devices are used in vehicles to control various function-specific units and to enable data exchange with a further control unit, such as a central vehicle controller, for example. In this case, the individual control devices are typically connected to one another via one or more bus systems, such as a vehicle bus, in particular. Besides specific functions such as controlling an actuator or querying a sensor, for example, such control devices also offer one or more interfaces for debugging, configuration or analysis. For security reasons, access to such interfaces is generally protected by a security key. Access to the corresponding interface or a function provided via that is not possible without knowledge of the key.

### SUMMARY

The teachings of the present disclosure may be used for further developing such control devices and methods for initializing them and for operating them. In particular, the teachings may be used to increase security of such control devices and/or to improve the flexibility of a security method.

For example, some embodiments include a control device (1), comprising: at least one data processing unit (7); at least one nonvolatile memory for storing program code for the data processing unit (7); and at least one interface (4, 5) for accessing services provided by the control device (1); wherein the control device (1) is configured to start in an open operating mode (S1) if a predetermined memory area (9e) of the at least one nonvolatile memory does not contain any data; to provide, in the open operating mode (S1), a first service (10a) for writing keys to the predetermined memory area (9c, 9d); to start in a protected operating mode (S2) if the predetermined memory area (9e) contains data; and to provide, in the protected operating mode (S2), at least one second service (10b, 10c, 10e) for querying and/or changing data stored in the at least one data processing unit (7) and/or the at least one nonvolatile memory (8), wherein accesses to the second service (10b, 10c, 10e) in the protected operating mode (S2) are safeguarded by means of at least one key stored in the predetermined memory area (9e).

In some embodiments, the control device (1) is furthermore configured to provide, in the open operating mode (S1), a third service for writing validation data, in particular a checksum and/or a validation pattern, for keys stored in the predetermined memory area (9e); and to check, in the protected operating mode (S2), an unchanged state of the keys stored in the predetermined memory area (9e) by means of the validation data before a query and/or change according to the at least one second service (10b, 10c, 10e) is answered and/or carried out.

In some embodiments, the control device (1) is furthermore configured to reject requests to the first service (10a) in the protected operating mode (S2) with an error message indicating the non-availability of the first service (10a).

In some embodiments, the control device (1) is furthermore configured to additionally provide the at least one second service (10b, 10c, 10e) in the open operating mode (S1), wherein accesses to the second service in the open operating mode (S1) are not safeguarded by means of a key stored in the predetermined memory area (9e).

In some embodiments, the control device (1) is furthermore configured to provide, in the open operating mode (S1) and/or the protected operating mode (S2), at least one fourth service (10d) for providing at least one application function, wherein accesses to the fourth service (10d) are not safeguarded by means of a key stored in the predetermined memory area (9e), either in the open operating mode (S1) or in the protected operating mode (S2).

In some embodiments, the at least one second service (10b, 10c, 10e) comprises at least one of the following services: a service (10e) for debugging via at least one internal interface (5), in particular a debug interface reachable by means of needle contacts (6), wherein accesses to the service (10e) for debugging in the protected operating mode (S2) are safeguarded by means of at least one key stored at a predetermined address of the at least one nonvolatile memory (8); a service (10c) for accesses to measurement and calibration data via a bus interface (4), in particular for accesses according to the Universal Measurement and Calibration Protocol, XCP, via a vehicle bus interface (4), wherein the service (10c) for accesses to measurement and calibration data does not allow read accesses to the predetermined memory area (9e); and/or a service (10b) for writing the program code for the data processing unit (7) via a bus interface, in particular a bootloader or initialization code for writing firmware via a vehicle bus interface (4) to the at least one nonvolatile memory (8), wherein the service (10b) for writing does not allow write accesses to the predetermined memory area (9e).

In some embodiments, the at least one nonvolatile memory (8) is configured as a flash memory, in particular as an integrated flash memory of a microcontroller (2), wherein the flash memory has a plurality of only jointly erasable memory pages, and each of the memory pages has a plurality of memory blocks which are one-time writable after an erase operation, and each key is stored by means of a dedicated write operation in at least one memory block of a common memory page which forms the predetermined memory area (9e).

As another example, some embodiments include a method for initializing a control device (1) comprising at least one data processing unit (7), at least one nonvolatile memory (8) for storing program code for the data processing unit (7), and at least one interface (4, 5) for accessing services provided by the control device (1), in particular the control device (1) as claimed in any of claims 1 to 7, wherein the method comprises: starting (S11) the control device (1) in an open operating mode (S1); writing (S12), by means of a first service (10a), at least one key to a predetermined memory area (9e) of the at least one nonvolatile memory (8) in the open operating mode (S1); switching (S13) to a protected operating mode (S2) after writing the at least one key; and offering at least one second service (10b, 10c, 10e) for querying and/or changing data stored in the at least one data processing unit (7) and/or the at least one nonvolatile memory (8) in the protected operating mode (S2), wherein an access to the second service (10b, 10c, 10e) is safeguarded by the at least one key written in the predetermined memory area (9e).

In some embodiments, at least starting (S11), writing (S12) and switching (S13) are carried out in a concluding phase of a process for producing the control device (1), after the assembly thereof and before the delivery thereof, in particular in the context of a functional test of the control device (1).

In some embodiments, wherein switching (S13) to the protected operating mode (S2) comprises the following: calculating at least one checksum for keys stored in the predetermined memory area (9e); storing the at least one checksum in the predetermined memory area (9e); optionally, storing a validation pattern in the predetermined memory area (9e); generating a confirmation signal, after writing the at least one checksum and, optionally, the validation pattern; and restarting the control device (1), wherein during the restart the data processing unit (7) recognizes the data stored in the predetermined memory area (9e) and puts the control device (1) into the protected operating mode (S2).

### BRIEF DESCRIPTION OF THE DRAWINGS

Further advantageous configurations are specified in the appended patent claims and the following detailed description of exemplary embodiments. The teachings of the present disclosure are further described in detail below on the basis of a specific exemplary embodiment with reference to the appended figures, in which:

FIG. 1 shows a schematic illustration of an example control device incorporating teachings of the present disclosure;

FIG. 2 shows a schematic illustration of the memory content of an example nonvolatile memory incorporating teachings of the present disclosure;

FIG. 3 shows a state diagram of the control device of FIG. 1;

FIG. 4 shows services and interfaces provided by the control device of FIG. 1;

FIG. 5 shows a flowchart of an method incorporating teachings of the present disclosure for initializing the control device;

FIG. 6 Shows a Flowchart of an Example Method Incorporating

teachings of the present disclosure for writing a key;

FIG. 7 shows a flowchart of an example method incorporating teachings of the present disclosure for locking a memory area with keys stored therein; and

FIG. 8 shows a flowchart of an example method incorporating teachings of the present disclosure for validating stored keys.

### DETAILED DESCRIPTION

Some embodiments of the teachings herein include a control device which comprises at least one data processing unit, at least one nonvolatile memory for storing program code for the data processing unit, and at least one interface for accessing services provided by the control device. In this case, the control device is configured to start in an open operating mode if a predetermined memory area of the at least one nonvolatile memory does not contain any data, and to provide, in the open operating mode, a first service for writing keys to the predetermined memory area. The control device is furthermore configured to start in a protected operating mode if the predetermined memory area contains data, and to provide, in the protected operating mode, at least one second service for querying and/or changing data stored in the at least one data processing unit and/or the at least one nonvolatile memory, wherein accesses to the second service in the protected operating mode are safeguarded by means of at least one key stored in the predetermined memory area.

Providing the two aforementioned operating modes and the associated services makes it possible, in particular, for an individual key to be stored once in a predetermined memory area of the control device after completion of the control device. In this way, control devices can be individualized, that is to say safeguarded against unauthorized accesses by means of one or more individual keys. In this case, the key(s) is/are written to the predetermined memory area by a corresponding first service of the control device itself, with the result that it is not necessary, in particular, to fixedly predefine the corresponding keys directly in a program code, in particular a boot code of the data processing unit. In this case, the first service allows the writing of a plurality of keys, with the result that, if appropriate, different services can be safeguarded by different keys.

In some embodiments, in the open operating mode, a third service for writing validation data can be offered by the control device, which third service allows the keys stored in the predetermined memory area to be additionally safeguarded by a checksum and/or a validation pattern.

In some embodiments, further accesses to the first service are not possible in the protected operating mode. By way of example, requests to the first service in the protected operating mode can be rejected with an error message indicating the non-availability of the first service.

By contrast, the second service can be additionally reachable in the open operating mode as well, for example in order to enable system tests or similar functions in a concluding phase of the production of the control device.

Examples of second services safeguarded by one or more keys are, in particular, a service for debugging, a service for accesses to measurement and calibration data and/or a service for writing program code for the data processing unit of the control device. Such services can be reachable via general or specific interfaces and/or by way of protocols correspondingly adapted to the service.

The at least one nonvolatile memory is for example a flash memory, in particular an integrated flash memory of a microcontroller. In this case, it is advantageous that individual memory cells of memory pages, for example one or more memory pages in which the keys of the predetermined memory area are stored, cannot be erased individually, but rather only page by page. This additionally makes it more difficult to subsequently manipulate keys stored in the control device.

Some embodiments include a method for initializing a control device comprising at least one data processing unit, at least one nonvolatile memory for storing program code for the data processing unit, and at least one interface for accessing services provided by the control device. In particular, this can involve a control device in accordance with the first aspect. An example method comprises:
starting the control device in an open operating mode;
writing, by means of a first service, at least one key in a predetermined memory area a of the at least one nonvolatile memory in the open operating mode;
switching to a protected operating mode after writing the at least one key; and
offering at least one second service for querying and/or changing data stored in the at least one data processing unit and/or the at least one nonvolatile memory in the protected operating mode, wherein an access to the second service is safeguarded by the at least one key written in the predetermined memory area.

The described methods make it possible to individualize a control device by means of one or more keys, for example in the context of a concluding functional test and/or directly before the control device is delivered to a customer.

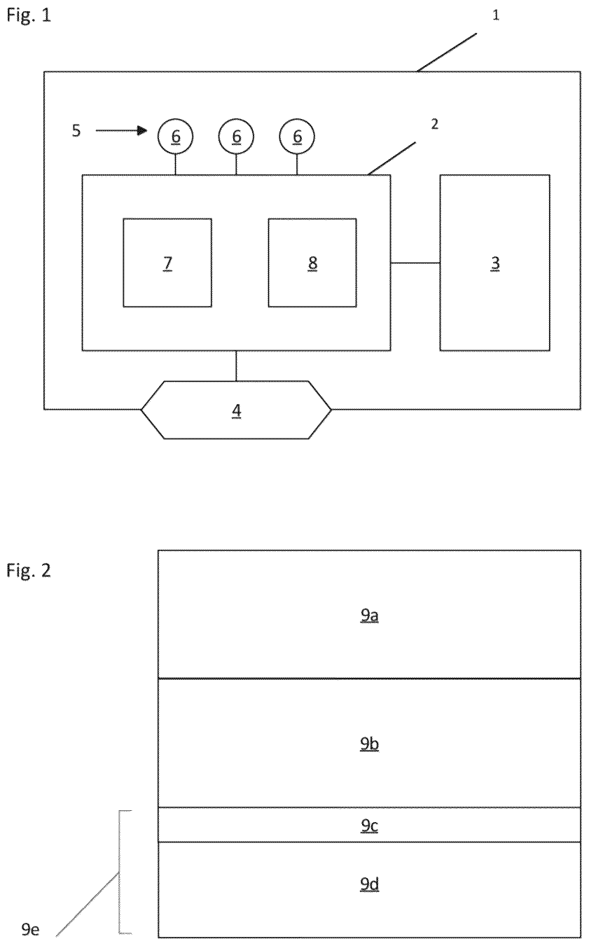

FIG. 1 schematically shows the setup of an electronic control device 1 (referred to as: electronic control unit) incorporating teachings of the present disclosure. In the exemplary embodiment, the control device 1 comprises a microcontroller 2, a sensor circuit 3 and a vehicle bus interface 4. Furthermore, the control device 1 comprises a further, internal interface 5, which is formed by a plurality of needle contacts 6 in the exemplary embodiment. The internal interface 5 is used in the context of production, in particular, in order to carry out functional tests at a very low level. After a housing of the control device 1 has been closed and sealed, if appropriate, the internal interface 5 is generally no longer reachable from outside. By contrast, the vehicle bus interface 4 remains accessible even after installation of the control device 1, for example in a motor vehicle, via a corresponding bus system, in particular a vehicle bus, such as with a CAN bus, for example.

In the exemplary embodiment, the microcontroller 2 comprises a data processing unit 7 and an internal nonvolatile memory 8, embodied as a flash memory. Program code for operating the data processing unit 7 or the control device 1 and also associated data of the control device 1 are stored in the nonvolatile memory 8. It goes without saying that instead of a single internal flash memory, it is also possible to provide one or more internal and/or external nonvolatile memories 8 for storing program code and/or data within the control device 1.

FIG. 2 schematically shows the content of the nonvolatile memory 8 incorporating teachings of the present disclosure. The memory 8 is divided into a plurality of memory areas 9a to 9d. By way of example, a first memory area 9a stores program code for a called bootloader or flash bootloader (FBI) or initialization code, which is executed immediately after the starting of the control device 1, in particular when an operating voltage is applied to the data processing unit 7. Further program code and associated data are stored in a second memory area 9b. For this purpose, for example by way of the bootloader or the initialization code, the control device typically offers a service for writing program code to the nonvolatile memory 8. By way of example, application-specific functions for the sensor circuit 3 or specific service programs for debugging or for access to measurement and calibration data can be stored in the second memory area 9b.

In the present case, the memory areas 9c and 9d serve for storing keys, in particular security keys for encrypting and/or authenticating accesses to predetermined interfaces or services of the control device 1. In this case, in the exemplary embodiment, only a single key, in particular for a service for debugging, is stored in the third memory area 9c. A plurality of different keys for access to different services of the control device 1 are stored in the fourth memory area 9d.

In the exemplary embodiment, the areas 9c and 9d form a contiguous memory area 9e for storing security keys. In this case, the keys stored in the contiguous memory area 9e are stored, protected and used in a similar way, as described below.

In some embodiments, the memory area 9c is situated in a different memory area, for example within the memory area 9a. In this case, the key for the service for debugging can also be permanently written to the nonvolatile memory 8, for example by corresponding patching of a hexadecimal code that also contains the program code of the bootloader or the initialization code. In this case, the functions described below relate only to the memory area 9d.

As described below, the control device 1 offers various services for access to data of the microcontroller 2 and in particular to data stored in the nonvolatile memory 8. Access to the memory areas 9c or 9d is not possible in this case, however. Such requests are for example intercepted and prevented by the bootloader or initialization code or not even offered in the first place via the interfaces 4 or 5.

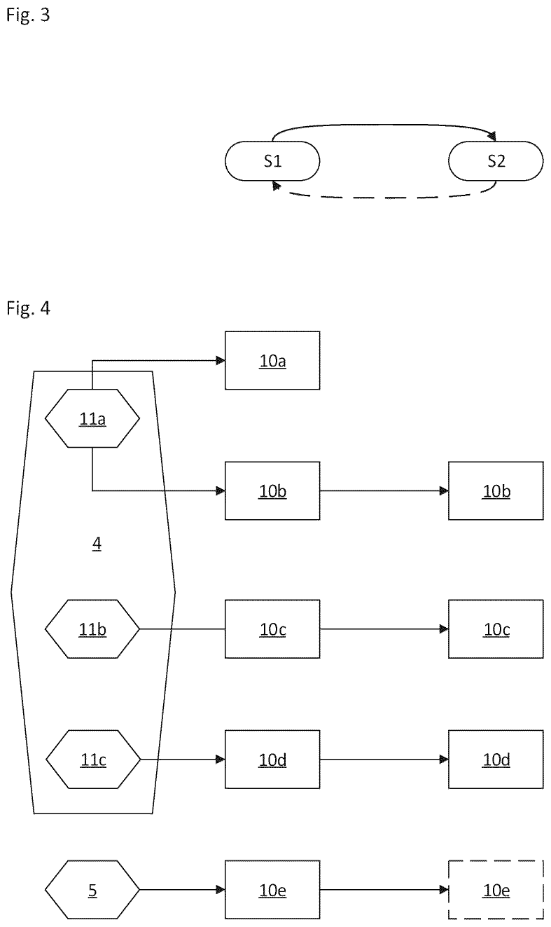

FIG. 3 shows a state diagram of the control device 1 from FIG. 1. That reveals that the control device 1 can be operated in a first, open operating mode S1 or a second, protected operating mode S2. As described in detail below, the control device switches from the open operating mode S1 to the protected operating mode S2 by writing and, if appropriate, validating keys. Return from the protected operating mode S2 to the open operating mode S1 is typically not provided. The latter may however be forced, if appropriate, by the entire memory content of the nonvolatile memory 8 being erased, for example by way of a corresponding service for resetting the control device 1 to a basic state before individualization.

FIG. 4 shows by way of example different services 10a to 10e that are provided by the control device 1 of FIG. 1. The different services are reachable in part via different interfaces and/or by way of different protocols. Furthermore, not all the services are reachable in each of the two operating modes S1 and S2. In FIG. 4, the services that are reachable in the protected operating mode S2 are presented in the right-hand column. The services that are reachable in the open operating mode S1 are presented in the middle column. The interfaces or protocols respectively used for access to the corresponding services are illustrated in the left-hand column.

A service 10a for one-time writing of keys to the memory 8 of the control device 1, and if appropriate validation of said keys, is reachable exclusively in the open operating mode S2. In the exemplary embodiment described, this service is reachable via a logical Unified Diagnostic Services (UDS) interface 11a according to ISO 14229-1, which is made available via the vehicle bus interface 4, for example. Overwriting or erasing of keys is neither provided nor possible even in the open operating mode.

If the service 10a for writing keys were reachable in the protected operating mode S2 as well, in principle this would result in the possibility of further security violations by the subsequent programming of keys that would need to be intercepted by comparatively complex security mechanisms in order not to compromise the security of the control device 1. By contrast, masking or hiding the service 10a in the protected operating mode S2 means that only one-time programming of keys is possible, in particular directly after the conclusion of production. As a result, such problems are avoided from the outset, and so the implementation of the service 10a can be configured significantly more simply.

In the exemplary embodiment, the bootloader or initialization code furthermore offers a service 10b for the programming of parts of the nonvolatile memory 8, in particular of the second memory area 9b, both in the open operating mode S1 and in the protected operating mode S2. This service can be offered via a specific interface or likewise via the UDS interface 11a, as illustrated in FIG. 4.

Moreover, a service 10c for access to measurement and calibration data via an XCP interface 11b or by way of the “Universal Measurement and Calibration Protocol” according to standard ASAM MCD-1 XCP is offered both in the open operating mode S1 and in the protected operating mode S2.

Typically, the control device 1 both in the open operating mode S1 and in the protected operating mode S2 offers one or more services 10d for implementing device-specific functions, such as reading out sensor values of the sensor circuit 3, for example. Accesses to such user functions generally take place via an unprotected interface 11c, for example of the vehicle bus interface 4, and are therefore not described hereinafter.

Finally, a service 10e for debugging, also referred to as a debug service, via the internal interface 5 is available in the open operating mode S1 and, optionally, in the protected operating mode S2. If the service 10e for debugging is also available in the protected operating mode S2, it optionally also makes it possible to reset the control device 1 to a basic state as indicated in FIG. 3. In this case, the internal memory 8 is completely erased, for example, and so none of the data previously stored by the control device 1 can subsequently be read out any more.

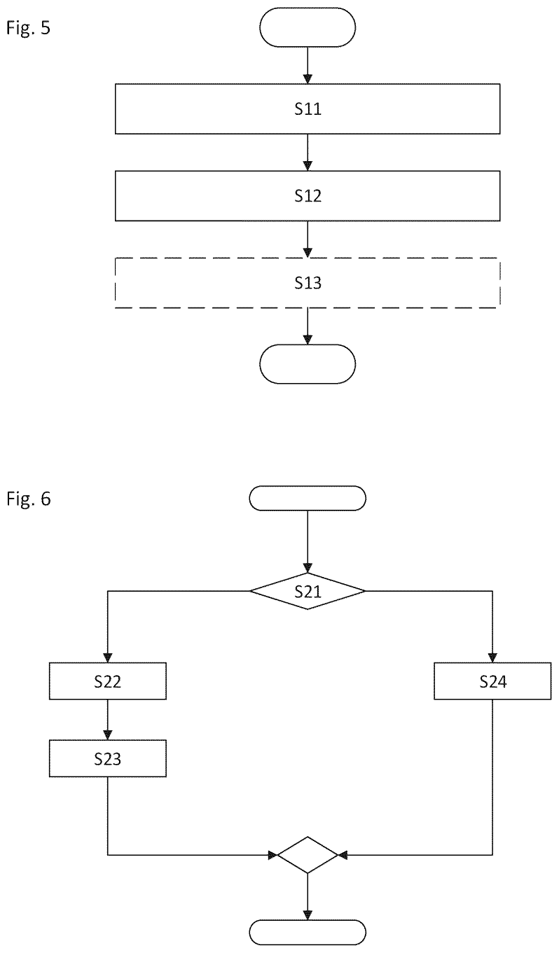

FIG. 5 schematically shows an initialization of the control device 1 of FIG. 1. Accordingly, in a step S11, the control device 1 is started in a state in which the memory area 9e does not yet contain any keys. This is the case for example in the context of a functional test directly after completion of the control device 1. A bootloader that is written to the first memory area 9a in this phase or beforehand recognizes that the memory area 9e does not yet contain data, and thereupon starts the control device 1 in the open operating mode S1.

In the step S12, one or more keys can subsequently be written to the memory area 9e using the service 10a. In the exemplary embodiment, this is done using a corresponding UDS service for writing security keys with a predetermined identifier. In some embodiments, in this operating mode, a special key, for example a debug key for the service 10e for debugging, can also be written to a fixed address, in particular to the memory area 9c.

In a subsequent step S13, the control device 1 is put into the protected operating mode S2. In some embodiments, the data written to the memory area 9e are validated beforehand. Depending on the implementation, all keys of the entire memory area 9e or only the keys stored in the memory area 9d are taken into account in this case. At the latest during a subsequent restart, the control device 1 ascertains that data have already been stored in the memory area 9e, and starts in the protected operating mode S2 from this point in time. The first service 10a thus deactivates itself.

FIG. 6 shows in detail the steps S21 to S24 performed by the service 10a when writing keys to the memory area 9e.

A first step S21 involves checking whether a corresponding partial memory area of the memory area 9e for storing keys is still empty, i.e. does not contain data. In the case of a flash memory, this means that all the bits of the corresponding partial memory area are set, that is to say consist of a pattern of all ones. By way of example, keys can be stored differently by means of different identifiers. In this case, a check is made to establish whether a key with an identifier indicated as parameter has not yet been stored in the memory area 9e. In this case, the identifier can be stored explicitly, for example in the form of a table, or merely serve as an indication for a predetermined partial memory area of the memory area 9e, for example the index 0 for the key in the memory area 9c.

If this is the case, in step S22, a key transferred as further parameter is written to a corresponding partial memory area of the memory area 9e. By way of example, it is possible to store the first key with a fixedly predefined identifier in the memory area 9c while further keys are progressively written to the memory area 9d. If the write operation is successful, the service 10a confirms this in step S23 with a confirmation message via the UDS interface 11a.

If step S21 reveals that the partial memory area for storing the corresponding key had already been previously written to, an error message is reported back, by contrast, in step S24. In the exemplary embodiment, this is an indication that the corresponding UDS service is not provided by the control device 1.

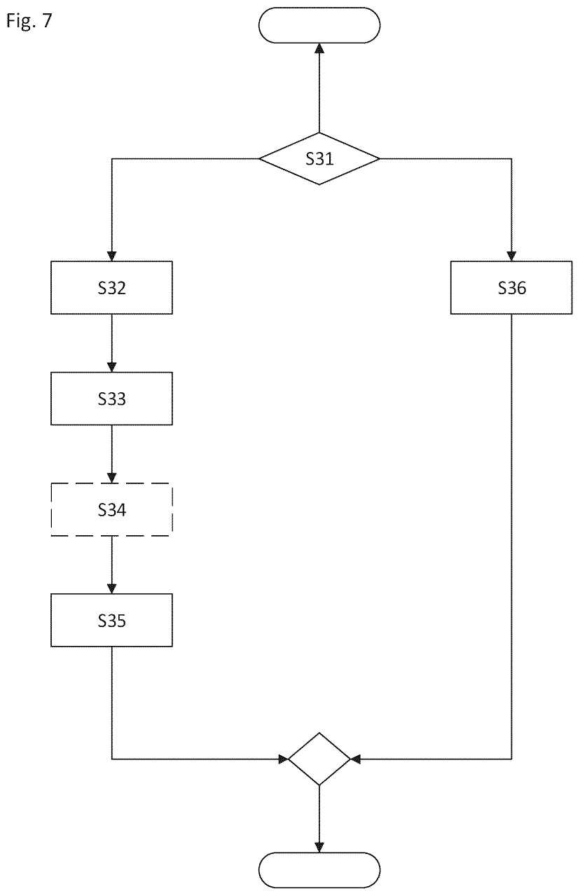

In some embodiments, the steps S22 and S23 can be performed repeatedly in succession, for example in order to store a plurality of keys with different identifiers in the memory area 9e. Once all intended keys have been stored in the memory area 9e, the method in accordance with FIG. 7 is optionally performed, which method finally locks the memory area 9e.

In that method, a first involves checking whether a partial memory area for writing validation data does not yet contain data.

In step S32, a checksum in the form of a CRC checksum having a predetermined length, for example 4 bytes, is calculated over at least the memory area 9d, preferably over the entire memory area 9e. The CRC checksum is written to the memory area 9e where the keys are also stored, i.e. in particular to the memory area 9d.

Furthermore, in a first step S34 optionally a validation pattern is written to the memory area 9e. By way of example, remaining memory cells of a corresponding memory page or a predetermined number of memory cells can be filled with a predefined validation pattern in order to increase the difficulty of subsequently adding keys.

In a concluding step S35, the function reports back a corresponding positive confirmation message via the UDS interface 11a.

By contrast, if the check in step S31 already reveals that the partial memory area for the CRC checksum or the validation pattern is filled with data, the corresponding function reports back an error message in step S36. As described above, this can be in particular a message indicating that a corresponding UDS service is not supported. Consequently, the function for locking the memory area 9e also constitutes a function which can be successfully implemented only once and only in the open operating mode S1.

After the function for locking the memory area 9e has been called, the service 10a for storing keys is no longer available. Even if the service 10a for writing keys could be called again, such keys would no longer be taken into account in the stored validation data and would thus lead to an error in the next validation, as described below.

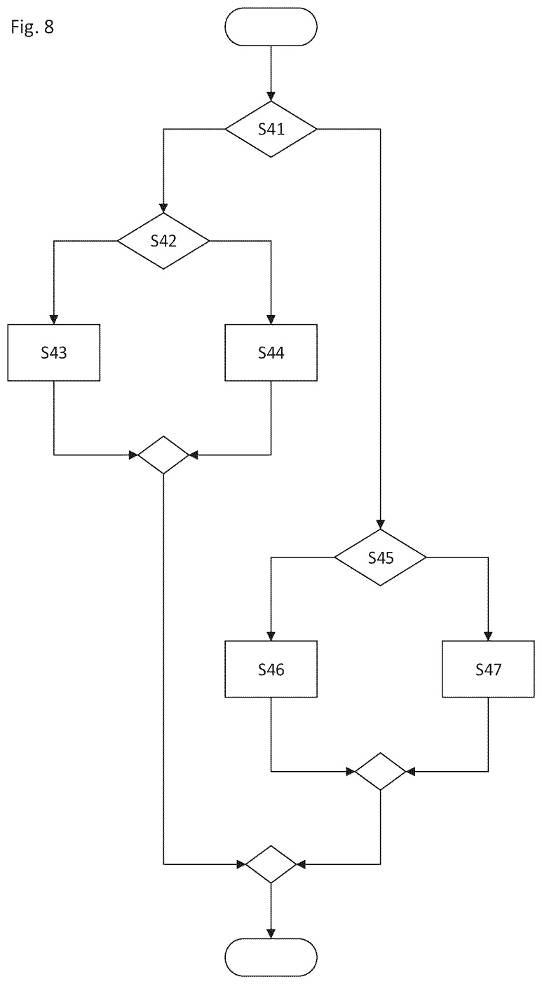

FIG. 8 shows a method for checking security keys during the operation of the control device 1, in particular in the protected operating mode 2. The function illustrated in FIG. 8 is implemented in particular whenever parts of the program code access a key stored in the memory area 9e. By way of example, the method is implemented by the program code of the bootloader or of the initialization code.

A first step S41 involves checking whether the memory area 9e, in particular the memory area 9d, contains validation data.

If this is not the case, a subsequent step S42 involves checking whether the memory area 9e quite generally contains keys.

If this is not the case either, the control device 1 is still in the open operating mode S1, in which accesses are possible without security keys in step S43. If corresponding UDS or XCP functions nevertheless expect a key as parameter, it is possible, for example, to call the corresponding function with any desired key or without indication of the corresponding parameter. By way of example, it is possible to call the service 10b for programming the third memory area 9d with any desired key and to call the service 10c without indication of a key.

If step S42 reveals that a key for the corresponding service is stored in the memory area 9c and/or 9d, the corresponding service is protected by the use of the corresponding key in step S44. Accesses with a different key than the stored key are not possible in this case.

If step S41 already reveals that validation data are stored in the memory area 9d, firstly the validity of a checksum and/or of the validation pattern is checked in a step S45.

If the stored checksum and/or the stored validation pattern are/is valid, in a step S46 accesses are permitted only by means of the stored key, as already described above with reference to the step S44.

By contrast, if the check in step S45 reveals that the checksum and/or the validation pattern are/is erroneous, the control device 1 is put into a further, blocked operating mode. In the blocked operating mode, any accesses to protected services, such as in particular the services 10a to 10c and 10e, are permanently blocked. If appropriate, the control device 1 can also react to such a security problem by the entire nonvolatile memory 8 being erased and the control device being put back into the open operating mode S1.

### LIST OF REFERENCE SIGNS

1 control device
2 microcontroller
3 sensor circuit
4 vehicle bus interface
5 internal interface
6 needle contact
7 data processing unit
8 nonvolatile memory
9a to 9e memory areas
10a service for writing keys
10b service for programming
10c service for accesses to measurement and calibration data
10d service for implementing device-specific functions
10e service for debugging
11a UDS interface
11b XCP interface
11c unprotected interface
S1 open operating mode
S2 protected operating mode
S11 to S47 method steps

What is claimed is:

1. A control device comprising:
at least one data processing unit;
at least one nonvolatile memory for storing program code for the data processing unit; and
at least one interface for accessing services provided by the control device;
wherein the control device is configured:
to start in an open operating mode if a predetermined memory area of the at least one nonvolatile memory does not contain any data and;
to provide, in the open operating mode, a first service for writing keys to the predetermined memory area; or
to start in a protected operating mode if the predetermined memory area contains data and
to provide, in the protected operating mode, at least one second service for querying and/or changing data stored in the at least one data processing unit and/or the at least one nonvolatile memory;
wherein accesses to the second service in the protected operating mode are safeguarded by means of at least one key stored in the predetermined memory area.

2. The control device as claimed in claim 1, wherein the control device is configured:
to provide, in the open operating mode, a third service for writing validation data, in particular a checksum and/or a validation pattern, for keys stored in the predetermined memory area; and
to check, in the protected operating mode, an unchanged state of the keys stored in the predetermined memory area using the validation data before a query and/or change according to the at least one second service is answered and/or carried out.

3. The control device as claimed in claim 1, wherein the control device is furthermore configured to reject requests to the first service in the protected operating mode with an error message indicating the non-availability of the first service.

4. The control device as claimed in claim 1, wherein the control device is furthermore configured to additionally provide the at least one second service in the open operating mode, wherein accesses to the second service in the open operating mode are not safeguarded by a key stored in the predetermined memory area.

5. The control device as claimed in claim 1, wherein:
the control device is furthermore configured to provide at least one fourth service for providing at least one application function; and
accesses to the fourth service are not safeguarded by means of a key stored in the predetermined memory area.

6. The control device as claimed in claim 1, wherein the at least one second service comprises at least one of the following services:
a service for debugging via at least one internal interface, wherein accesses to the service for debugging in the protected operating mode are safeguarded by means of at least one key stored at a predetermined address of the at least one nonvolatile memory;
a service for accesses to measurement and calibration data via a bus interface via a vehicle bus interface, wherein the service for accesses to measurement and calibration data does not allow read accesses to the predetermined memory area; and/or
a service for writing the program code for the data processing unit via a bus interface, in parts wherein the service for writing does not allow write accesses to the predetermined memory area.

7. The control device as claimed in claim 1, wherein:
the at least one nonvolatile memory comprises a flash memory with a plurality of only jointly erasable memory pages; and
each of the memory pages has a plurality of memory blocks which are one-time writable after an erase operation; and
each key is stored by means of a dedicated write operation in at least one memory block of a common memory page which forms the predetermined memory area.

8. A method for initializing a control device having
at least one data processing unit,
at least one nonvolatile memory for storing program code for the data processing unit, and
at least one interface for accessing services provided by the control device, the method comprising:
starting the control device in an open operating mode;
writing with a first service, at least one key to a predetermined memory area of the at least one nonvolatile memory in the open operating mode;
switching to a protected operating mode after writing the at least one key; and
offering at least one second service for querying and/or changing data stored in the at least one data processing unit and/or the at least one nonvolatile memory in the protected operating mode;
wherein an access to the second service is safeguarded by the at least one key written in the predetermined memory area.

9. The method as claimed in claim 8, further comprising conducting a functional test of the control device, including starting, writing, and switching before the delivery thereof.

10. The method as claimed in claim 8, wherein switching to the protected operating mode comprises:
calculating at least one checksum for keys stored in the predetermined memory area;
storing the at least one checksum in the predetermined memory area;
generating a confirmation signal, after writing the at least one checksum; and
restarting the control device;
wherein during the restart the data processing unit recognizes the data stored in the predetermined memory area and puts the control device into the protected operating mode.
